(19) United States
(12) Patent Application Publication
(10) Pub. No.: US 2017/0094415 A1
(43) Pub. Date: Mar. 30, 2017

(54) A CAP FOR AN ELECTRO-ACOUSTIC TRANSDUCER

(71) Applicant: DALI A/S, Norager (DK)

(72) Inventor: Kim KRISTIANSEN, Silkeborg (DK)

(21) Appl. No.: 15/310,866

(22) PCT Filed: May 8, 2015
(86) PCT No.: PCT/DK2015/050120

§ 371 Date: Nov. 14, 2016

(30) Foreign Application Priority Data
May 15, 2014 (DK) PA 2014 70287

(51) Int. Cl. H04R 9/02; H04R 31/00

(52) U.S. Cl. CPC H04R 9/025; H04R 31/006; H04R 2209/024

(57) ABSTRACT

The invention relates to a cap (1) for an electro-acoustic transducer (2), which cap (1) comprises a first portion (3) having a form matching in shape and dimensions at least a top part of a magnetic center pole piece (4) of the transducer (2) and an opening (5) for receiving said magnetic center pole piece (4), wherein the first portion (3) includes at least one recess (6) with reduced material thickness on a lateral face (7) of the first portion (3). Also, the invention relates to: (i) a method (100) of manufacturing a capped center pole piece for an electro-acoustic transducer (2); (ii) a capped center pole piece for an electro-acoustic transducer (2); and (iii) an electro-acoustic transducer (2) comprising the cap (1) or the capped center pole piece.

### FIELD OF THE INVENTION

The invention relates to a cap for an electro-acoustic transducer, which cap comprises a first portion having a form matching in shape and dimensions at least atop part of a magnetic center pole piece of the transducer and an opening for receiving said magnetic center pole piece.

Also, the invention relates to: (i) a method of manufacturing a capped center pole piece for an electro-acoustic transducer; (ii) a capped center pole piece for an electro-acoustic transducer; and (iii) electro-acoustic transducer comprising the cap or the capped center pole piece.

### BACKGROUND OF THE INVENTION

Normally, a magnetic material has a magnetic hysteresis loop characteristic, and the relation between magnetizing force and magnetic flux density is nonlinear. As a result, when the magnetic flux of a voice coil passes through a center pole piece and a plate near an air-gap, the magnetic reaction in the voice coil results in a distorted output signal from a loudspeaker. Various methods of eliminating such a distortion have been attempted, e.g., covering a center pole piece with a copper cap, which reduces the distortion that is introduced into the coil current by the inductance of the voice coil. However, this solution does not provide a constant and low inductance, which is independent from the position of the voice coil.

Hence, there is a need in the technical field of electro-acoustic transducers, particularly within distortion reduction caps for electro-acoustic transducers, of overcoming the abovementioned drawbacks of the state-of-the-art.

### ASPECTS OF THE INVENTION

The first aspect of the invention is to provide an improvement to the state-of-the-art. The second aspect of the invention is to solve the aforementioned drawbacks of the prior art by means of a solution that provides at the same time: (i) a magnetic field, which is not modulated by an AC current; (ii) a constant and low inductance, which is independent from the position of the voice coil; and a reduced corrosion of the cap.

### DESCRIPTION OF THE INVENTION

The aforementioned aspects of the invention are achieved by a cap as described in the preamble of claim 1, wherein the first portion includes at least one recess with reduced material thickness (e.g., 80% less with respect to the rest of the cap) on a lateral face of the first portion.

Alternatively, the first portion may include at least one aperture on a lateral face of the first portion. Herein, the term “aperture(s)” embraces, e.g., a trough-hole, an elongated hole, a rounded/oval hole, a slit and a set of holes/slits closely spaced apart from each other (e.g., within 1-20 mm distance).

Advantageously, the first portion may include at least one aperture and at least one recess with reduced material thickness on a lateral face of the first portion.

Advantageously, the cap of the invention may be applied to electro-acoustic transducers (e.g., loudspeakers, microphones), as well as to electro-mechanic transducers (e.g., actuators).

Normally, it is desirable that the L_{E}, i.e., the inductance, as a function of the excursion of the voice coil in a longitudinal axis is as constant as possible. The invention has the advantage with respect to the prior art that the L_{E} curve is approximately constant. That is because the electric current is reduced in the magnetic center pole piece and flows on the cap, where it branches out or reduces at the aperture or at the recess, respectively. Normally, short-circuiting the electric current by means of a cap reduces/eliminates the induction provoked by AC magnetic fields but results in an L_{E} that is dependent on the position of the voice coil. However, thanks to the one or more apertures or recesses on the cap, instead, the L_{E} becomes independent from the spatial displacement of the voice coil along the longitudinal direction. In particular, a recess has the further advantage with respect to an aperture (e.g., a hole/slit) of offering the cap protection against corrosion.

The size, form (e.g., an elongated hole in a direction parallel to the longitudinal axis of the center pole piece or a rounded/oval hole, which is easier to manufacture than an elongated hole), position, orientation (e.g., parallel to or having an angle with respect to the longitudinal axis of the cap) and number of apertures and recesses are significant design parameters. For example, the L_{E} curve becomes more constant according to the size and the position of the one or more apertures with respect to the magnet surrounding the center pole piece and the length of the voice coil. Theoretically, it is possible to tune the L_{E} curve in order to control in which interval the electro-acoustic transducer will optimally work in.

In an advantageous embodiment of the invention, the recess (and/or the aperture) is positioned on the lateral face of the first portion so as to face a voice coil and a top plate, wherein the recess (and/or the aperture) has a length in a direction parallel to a longitudinal axis of the first portion substantially equal to a length of the voice coil or a thickness of the top plate. Advantageously, the recess (and/or the aperture) may have a length within the range between half the thickness of the top plate and one and a half the length of the voice coil. This embodiment has the advantage that it is possible to linearize the voice coil inductance (L_{E}) to be within a small variation independent on the voice coil position on the longitudinal axis. For instance, when the top plate height is 4 mm, the pole center height is 26,65 mm, the voice coil length is 16 mm and the diameter of the center pole piece is 25 mm, the optimal effect is achieved with a copper cap having a thickness of 0.3 mm and two slits, wherein each slit has a length of 15 min. The result is an L_{E} that is linearized within +/−5% limits throughout a working excursion range of +/−8 mm, which is a factor 5 better than the current state-of-the art, where L_{E} lies within +/−25% limits throughout the same working excursion range of +/−8 mm.

In an advantageous embodiment of the invention, the first portion includes two recesses (or two apertures) positioned symmetrically with respect to the longitudinal axis of the first portion (i.e., the two recesses/apertures have a mirror symmetry with respect to the longitudinal axis of the first portion). In another advantageous embodiment of the invention, a number of recesses (and/or apertures) is substantially equally spaced along the lateral face of the first portion. These embodiments have the advantage that the cap of the invention has a mirror or a rotational symmetry with respect to the longitudinal axis of the cap, so that the magnetic field has the same intensity at both sides or all around the cap, thus achieving a balance in the air-gap, which reduces distortions with respect to an unbalanced configuration.

Advantageously, the cap may be formed so as to receive the center pole piece in all its height.

In an advantageous embodiment of the invention, the cap comprises a second portion having a form matching in shape and dimensions a top plate of the transducer and an opening for receiving said top plate, wherein the second portion includes at least one aperture and/or at least one recess with reduced material thickness on a lateral face of the second portion, which aperture or recess is positioned on the lateral face of the second portion so as to face the recess (or the aperture) on the lateral face of the first portion. The advantage of this embodiment is that the effects of the voice coil inductance modulation related to the voice coil position relative to the top of the magnet system are reduced and controlled.

In an advantageous embodiment of the invention, the cap comprises a third portion extending from the opening of the first portion to the opening of the second portion. The advantage of this embodiment is that it provides a mechanically-convenient fastening between first and second portions.

Note that the cap may also be constituted only of the second portion (with or without one or more apertures and/or one or more recesses with reduced material thickness), or the first and second portions without the third portion interconnecting them.

In an advantageous embodiment of the invention, the third portion has a drop-like form. The advantage of this embodiment with respect, for example, to the third portion laying on a plane perpendicular to the longitudinal axis of the first portion is that it provides more space in a longitudinal and/or in a transversal direction (depending on the depth and the width of the third portion) for the movement of the voice coil in the air-gap. In fact, the voice coil normally moves up and down in the air-gap, but also slightly to the sides.

Advantageously, the cap may be applied both a T-formed center pole piece and to a cylindrical/oval/squared/etc. center pole piece.

Advantageously, the cap may have a hole (e.g., a trough-hole) on the top face of the cap to permit ventilation of the center pole piece.

Advantageously, the cap may comprise a conductive material such as copper, brass, aluminium, silver, carbon, bronze, and combinations thereof.

Advantageously, the cap of the invention may be used with a center pole piece and/or a top plate comprising a material such as iron, cobalt, nickel, Soft Magnetic Composite material (SMC), and combinations thereof,

Advantageously, the cap and the center pole piece may be glued together, injection moulded or magnetic injection moulded.

Advantageously, an aperture may be generated by laser cut and a recess may be generated either by laser ablation or by pressing inwardly the corresponding portion of the lateral face of the cap.

Also, the aforementioned aspects of the invention are achieved by a method as described in the preamble of claim 8, wherein the method comprises:
providing a cap as described above;
placing the cap into a casting die adapted to receive the cap; filling the cap with a powder comprising a magnetic material (e.g., a magnetic conductive material); and
pressing the powder from the opening of the first portion, so that the powder fills the aperture and/or the recess of the cap. In particular, the powder will fill the recess if the latter is made from the inside of the cap,

The invention has the advantage that the cap is manufactured as a whole with the center pole piece. Consequently: (i) the required material is reduced, thus lowering the cost of the operation; (ii) centering the cap on the center pole piece is easier and more effective, i.e., it provides a lower tolerance than with conventional manufacturing processes; (iii) the air-gap (i.e., the distance between the center pole piece and the magnet surrounding the center pole piece) is increased, thus providing additional space for the movements of the voice coil in the air-gap, which has also an influence on the working range of the transducer; and (iv) the center pole piece does not need to be coated (e.g., with a layer of Epoxy material) to avoid corrosion (e.g., from air and damp), as in fact eventually only the material exposing out of the one or more apertures may need to be coated.

Advantageously, a center poi piece smaller than the cap may be placed in the casting die so that less powder is used in the manufacturing process.

Advantageously, the powder may comprise iron particles,

Advantageously, the method may further comprise a piston pressing the powder from the opening of the cap.

Advantageously, the method may further comprise a piston pushing the capped center pole piece out of the casting die.

Advantageously, the method may further comprise oxidizing the capped center pole Alternatively, the magnetic material that shall fill the one or more apertures may also be attached to the center pole piece, or the center pole piece may be directly manufactured with one or more protrusions that fit the one or more apertures. The cap may be then plugged and held tight to the center pole piece while being exposed to a magnetic field generated by a very strong magnetizer, which will then deform the cap and mate it adhere to the center pole piece.

Also, the aforementioned aspects of the invention are achieved by a capped center pole piece as described in the preamble of claim 9, wherein the capped center pole piece comprises a center pole piece and a cap as described above, wherein a magnetic material e.g., a magnetic conductive material) fills the aperture and/or the recess of the cap.

Typically, in order to focus the magnetic field (i.e., to force the flux lines to depart straight from the center pole piece and arrive straight to the magnet surrounding the center pole piece), the center pole piece is T-formed. With the capped center pole piece of the invention a similar effect is achieved, as in fact, when the cap has an aperture filled with magnetic material (e.g., iron), the magnetic field is forced to depart straight from the magnetic material in the aperture and to arrive straight to the magnet surrounding the center pole piece. As a consequence, the flux of the magnetic field is optimized.

Advantageously, an aperture filled with magnetic material provides a higher B_{L} (i.e., sound pressure), whereas a recess provides a lower L_{E}. Nevertheless, a combination of apertures and recesses may also be envisioned.

Also, the aforementioned aspects of the invention are achieved by an electro-acoustic transducer as described in the preamble of claim 11, wherein the transducer comprises a capped center pole piece as described above, or a center pole piece and a cap as described above.

Note that all the afore-mentioned advantages of the cap and the capped center pole piece are also met by the transducer.

Hereafter, the invention will be described in connection with drawings illustrating non-limiting examples of a cap for an electro-acoustic transducer.

### BRIEF DESCRIPTION OF THE DRAWINGS

FIG. 1: Cross-section view of a loudspeaker comprising a cap according to the invention.

FIG. 2A: Cap according to the prior art.

FIGS. 2B-C: Variants of a cap according to the invention.

FIG. 3A: Electric current flow for a cap according to the prior art.

FIGS. 3B-C: Electric current flow for variants of a cap according to the invention.

FIG. 4: L_{E} curves comparison

FIG. 5: Cap having a height smaller than the length of the voice coil.

FIG. 6: Cap with a drop-like third portion.

FIG. 7: Flow chart of a method of manufacturing a capped center pole piece.

### NOTATIONS

L: Length of an aperture or a recess

L_{vc}: Length of the voice coil

T: Thickness of the top plate

Z: Longitudinal axis of the first portion

1: Cap

2: Electro-acoustic transducer

3: First portion

4: Magnetic center pole piece

5: Opening of the first portion

6: Aperture or recess

7: Lateral face of the first portion

8: Magnetic top plate

9: Voice coil

10: Air-gap

11: Second portion

12: Third portion

15: Ventilation hole

### PREFERRED EMBODIMENTS OF THE INVENTION

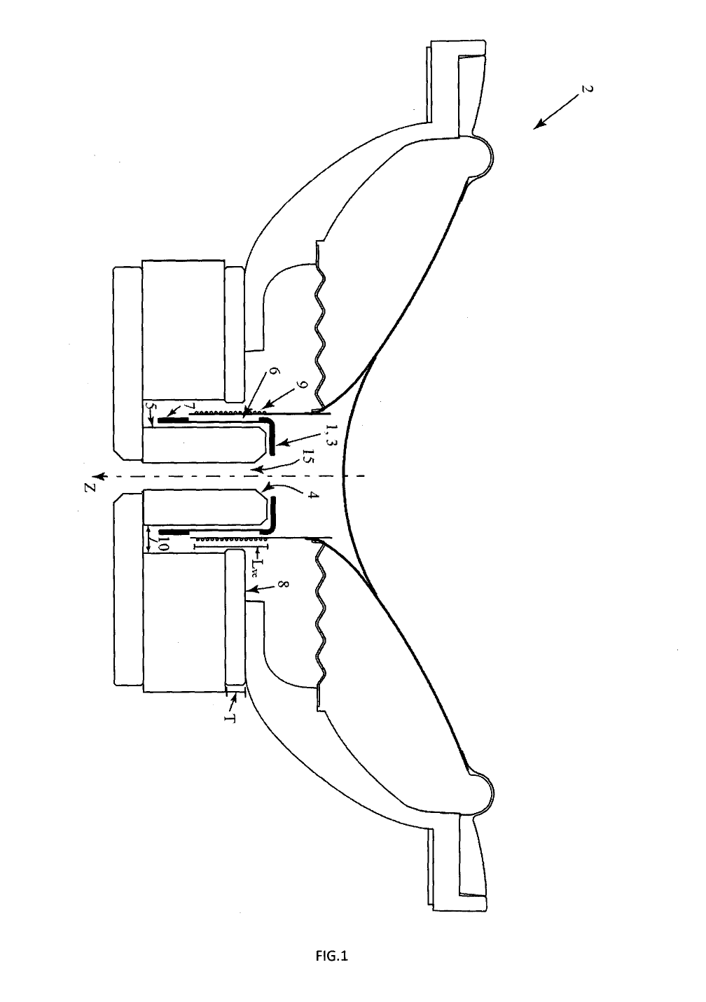

FIG. 1 shows a loudspeaker 2 comprising: a cylindrical center pole piece 4, a top plate 8 having a thickness T, an air-gap 10, a voice coil 9 having a length L_{vc} and adapted to move along a direction parallel to the longitudinal axis Z, and a cylindrical cap 1 having an opening 5 for receiving the center pole piece 4 and a ventilation hole 15. The cap 1 has two recesses 6 on its lateral face 7 that are positioned symmetrically with respect to the longitudinal axis Z and face the voice coil 9. In particular, the cap 1 is constituted only by the first portion 3.

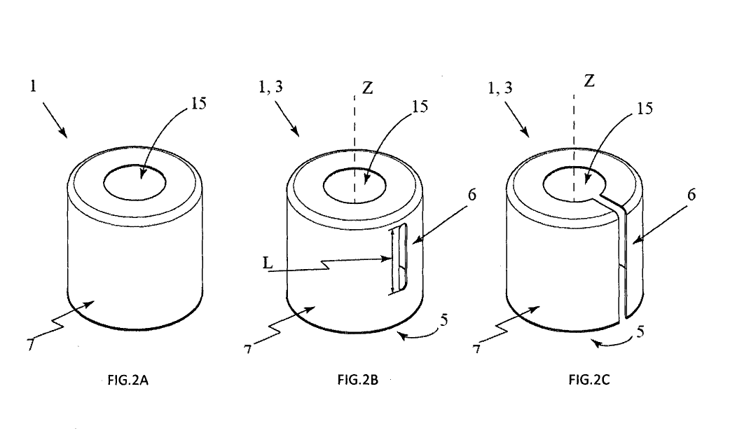

FIG. 2A shows a cylindrical cap 1 according to the prior art. It is noticeable that the cap 1 has a ventilation hole 15 on its top face, but no aperture or recess on its lateral face 7.

FIG. 2B shows a cylindrical cap 1 according to an embodiment of the invention. It is noticeable that the cap 1 has a ventilation hole 15 on its top face and a slit 6 on its lateral face 7. The slit 6 extends for length L along a direction parallel to the longitudinal axis Z of the cap 1. In particular, the cap 1 is constituted only by the first portion 3.

FIG. 2C shows a cylindrical cap 1 according to another embodiment of the invention. It is noticeable that the cap 1 has a ventilation hole 15 on its top face and a slit 6 that departs from the ventilation hole 15, crosses the top face of the cap 1, reaches the circumference at the top face of the cap 1, continues down on the later face 7 of the cap 1 along a direction parallel to the longitudinal axis Z and ends at the circumference at the bottom face of the cap 1.

Note that by adjusting, for example, the length L of the slit 6 (from the slit 6 in FIG. 2B to the slit 6 of FIG. 2C) the resulting effect can be regulated.

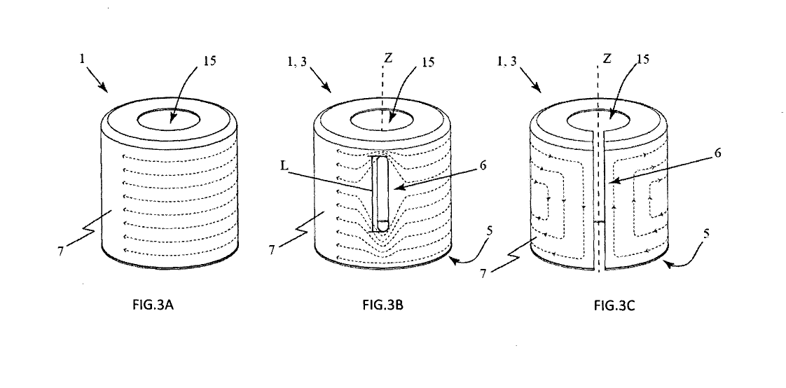

FIGS. 3A-C show a simplified model of the flow of the electric current on the caps 1 in FIGS. 2A-C. It is noticeable that the slit 6 in FIG. 3B branches out the electric current flowing on the cap 1.

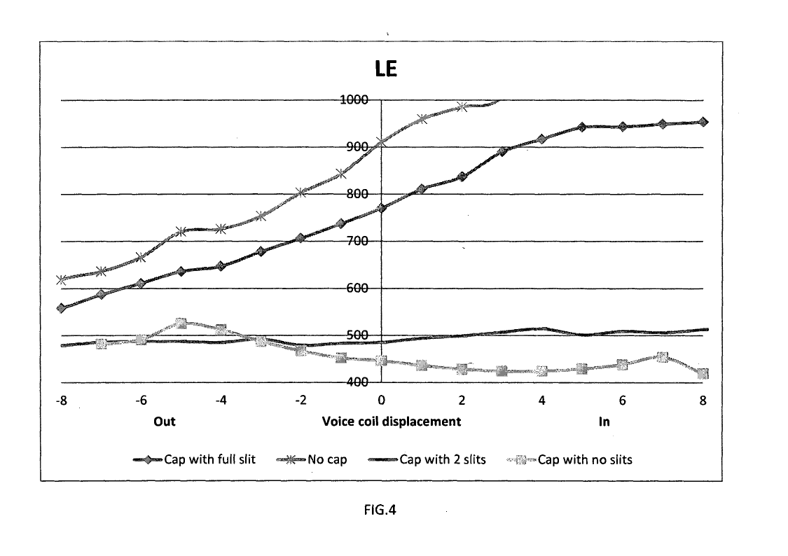

FIG. 4 shows the behaviour of L_{E} with respect to the voice coil 9 displacement in the same direction (In) or in an opposite direction (Out) with respect to the longitudinal axis Z. It is noticeable that: (i) the case with no cap 1 results in the highest positioned L_{E} curve in the diagram; the case with a cap 1 as in FIG. 2A results in a low positioned L_{E} curve, which is though dependent on the voice coil 9 displacement; (iii) the case with a cap 1 having two slits 6 as in FIG. 2B that are positioned symmetrically with respect to the longitudinal axis Z results in a low positioned L_{E} curve, which is practically independent from the voice coil 9 displacement; and (iv) the case with a cap 1 as in FIG. 2B results in an L_{E} curve that is shifted lower down with respect to the case with no cap 1.

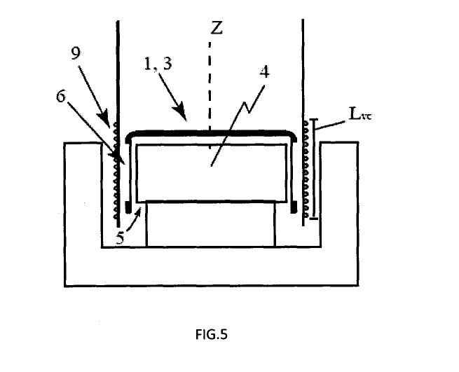

FIG. 5 shows T-formed center pole piece 4 of a loudspeaker. In this exemplary embodiment, contrarily to the embodiment of FIG. 1, the cap 1 has a height shorter than the length 1, of the voice coil 9. In particular, the magnet system is based on a center-placed magnet.

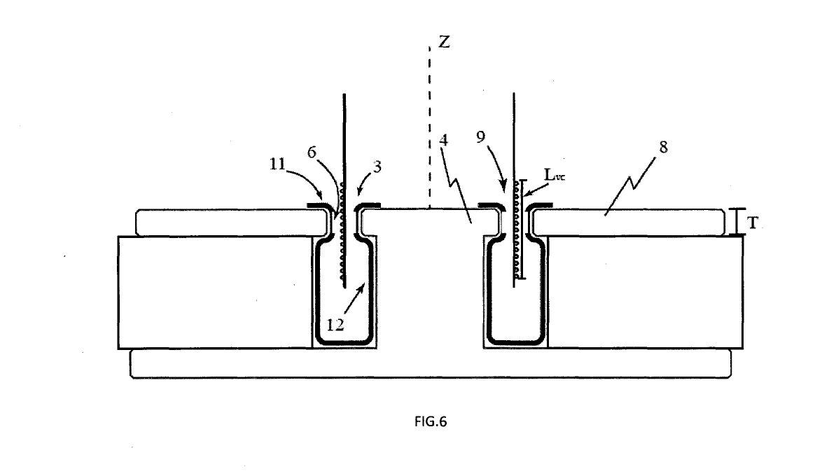

FIG. 6 shows a T-formed center pole piece 4 of a loudspeaker. In this exemplary embodiment, the cap 1 is composed of a first portion 3, a second portion 11 and a third portion 12 having a drop-like form. The second portion 11 has a recess 6 that faces a recess 6 on the first portion 3.

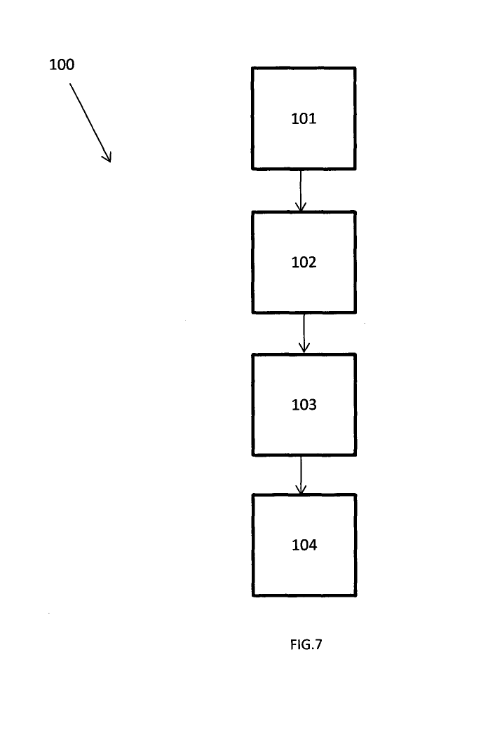

FIG. 7 shows a method 100 of manufacturing a capped center pole piece for an electro-acoustic transducer 2. The method 100 comprises: providing 101 a cap 1 as described above; placing 102 the cap 1 into a casting die adapted to receive the cap 1; filling 103 the cap 1 with a powder comprising a magnetic material; and pressing 104 the powder from the opening 5 of the first portion 3, so that the powder fills the aperture and/or the recess 6 of the cap 1.

1. A capes for an electro-acoustic transducer, which cap comprises a first portion having a form matching in shape and dimensions at least a top part of a magnetic center pole piece of the transducer and an opening for receiving said magnetic center pole piece, wherein the first portion includes at least one recesses with reduced material thickness on a lateral face of the first portion.

2. The cap according to claim 1, wherein the recess is positioned on the lateral face of the first portion so as to face a voice coil and a top plate, wherein the recess has a length in a direction parallel to a longitudinal axis of the first portion substantially equal to a length of the voice coil or a thickness of the top plate.

3. The cap according to claim 1, wherein the first portion includes two recesses positioned symmetrically with respect to the longitudinal axis of the first portion.

4. The cap according to claim 1, wherein a number of recesses is substantially equally spaced along the lateral face of the first portion.

5. The cap according to claim 1, wherein the cap comprises a second portion having a form matching in shape and dimensions the top plate of the transducer and an opening for receiving said top plate, wherein the second portion includes at least one aperture and/or at least one recess with reduced material thickness on a lateral face of the second portion, which aperture or recess is positioned on the lateral face of the second portion so as to face the recesses on the lateral face of the first portion.

6. The cap according to claim 5, wherein the cap comprises a third portion extending from the opening of the first portion to the opening of the second portion.

7. The cap according to claim 6, wherein the third portion, has a drop-like form.

8. A method of manufacturing a capped center pole piece for an electro-acoustic transducer, wherein the method comprises:
providing a cap according to claim 1;
placing the cap into a casting die adapted to receive the cap;
filling the cap with a powder comprising a magnetic material; and
pressing the powder from the opening of the first portion, so that the powder fills the aperture and/or the recess of the cap.

9. A capped center pole piece for an electro-acoustic transducer, wherein the capped center pole piece comprises a center pole piece and a cap according to claim 1, wherein a magnetic material fills the aperture and/or the recess of the cap.

10. An electro-acoustic transducer, wherein the transducer comprises a center pole piece and a cap according to claim 1.

11. An electro-acoustic transducer wherein the transducer comprises a center pole piece and a capped center pole piece according to claim 9.
